(19) United States
(12) Patent Application Publication
(10) Pub. No.: US 2010/0224538 A1
(43) Pub. Date: Sep. 9, 2010

(54) Method Of Filtering And Filter Device

(75) Inventor: Pierre Gerard Willem Nieuwland, Rotterdam (NL)

Correspondence Address: TROUTMAN SANDERS LLP;5200 BANK OF AMERICA PLAZA, 600 PEACHTREE STREET, N.E., SUITE 5200, ATLANTA, GA, 30308-2216, US

(73) Assignee: NTZ INTERNATIONAL HOLDING, ROTTERDAM (NL)

(21) Appl. No.: 12/303,812

(22) PCT Filed: Jun. 9, 2006
(86) PCT No.: PCT/IB06/01517

§ 371 Date: Dec. 8, 2008

(51) Int. Cl. B01D 35/147

(52) U.S. Cl. 210/130

(57) ABSTRACT

Method of filtering and a filter device having a housing (1), enclosing a filter element (4) fixated against an axial end cap (2) of the device, provided with a second end cap (8) internal to the housing, unconnectedly therewith closing of the opposite axial end face of the filter element (4), a spring element (6) being provided urging said internal cap (8) against said axial end face, and a by-pass valve (9) being provided in said end cap, opening to an internal cylindrical chamber of the filter element (4) against spring force of a valve spring (11), the cap spring (6) and the valve spring (11) being provided with a corresponding spring setting, such that at top side down, i.e. incorrect mounting of the device, the combination of internal cap and cap spring may act as a safety, i.e. by-pass valve.

The present invention relates to a filter device as defined in the preamble of claim 1.

Such filter devices are well known in the art and are for instance applied in automotive transmissions, e.g. between the transmission and an oil cooler. The known filter is however ass well applied in other applications.

A problem related to the known filters is the “fool proof” nature thereof, at least the extend to which such is qualitatively addressed in the design of the filter. This feature of the known filter is predominantly if not solely connected with the possibility to mount a filter inversely, in particular at replacement.

In the latter respect various solutions have been devised, all against the background of maintaining the design economic, i.e. to keep the device “sellable”.

It is an object of the present invention to provide an alternative solution in this respect. The invention thereto departs from filters and filter devices provided with a safety valve. Safety valves comprise a valve which may be biased against force of a spring means from a closing position to a position open for flow of hydraulics in case of emergency, i.e. in case of blocking of the filter. The present invention uses this principle for realising a fail safe design for inverse mounting, and thereby provides the filter or filter device with yet another spring provided with a corresponding spring characteristic, however acting in the opposite direction.

With the new method according to the present invention, at erroneous mounting, flow may pass through the filter in opposite direction, i.e. from inside to outside, rather than vice versa, while safety operation of the filter is still guaranteed.

At setting the method according to the invention into practice, such spring means may either act directly on to the valve, however, as in a preferred embodiment, may also act on a valve supporting structure such as a closure element or end cap for an axial end face of a filter, which element is in such case to be supported freely by such axial end face. With a latter arrangement any hydraulics to be released or to be released quickly from the inside-filter chamber will thus pass between a filter axial end face and a closure element lifted from said face, rather than via said by pass valve opening.

It is a further object of the present invention to improve a particular filter design related to so-called in depth filters that are used “in-line” rather than in by-pass configuration as had for long time been typical for such kind of filters. Filter devices with in dept filters, arranged in in-line configuration are provided with a by-pass valve for use during normal operation rather than for use as a safety valve, so as to meet demanding conditions of operation. This solution is known from international patent application PCT/IB2004/000419 in the name of Applicant.

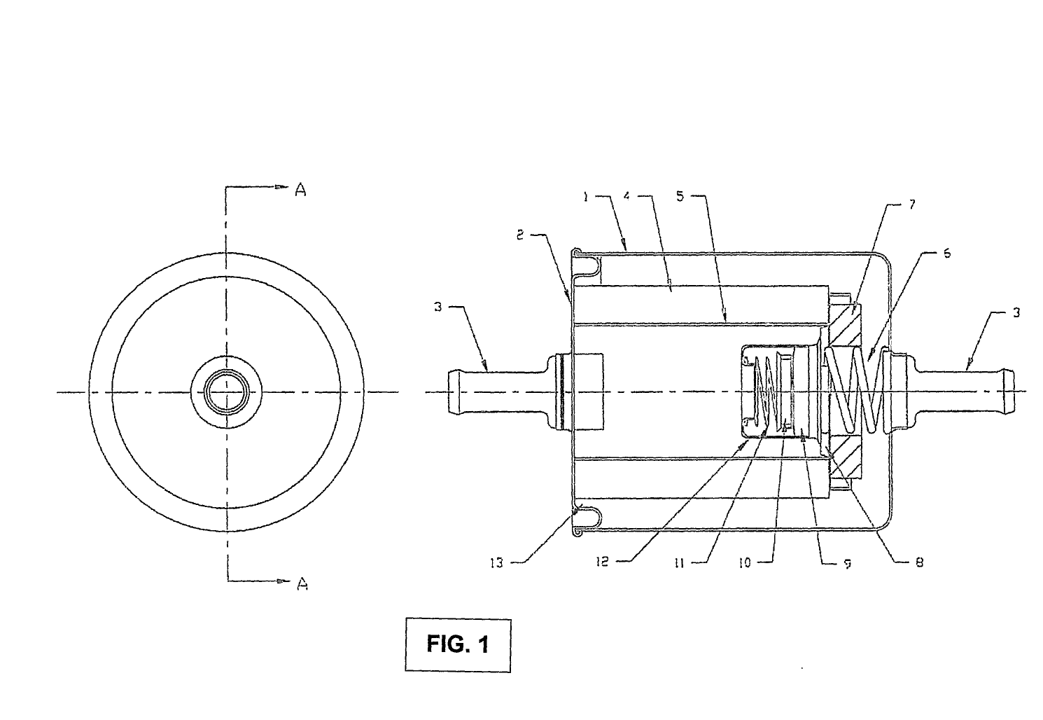

The invention will now be elucidated further along a drawing in which FIG. 1 is a top view of a bottom side of a filter device, combined with sectional view A-A.

In the FIGURE, identical reference numbers relate to identical or at least comparable technical features.

FIG. 1, to the left hand side shows a plan view of the bottom side of a filter device to which the invention relates, while the right hand side, by means of an axial cross section shows the interior of the device, in accordance with the present invention. A housing 1, here embodied generally cup-shaped, encloses a filter element 4. The housing 1 is closed off by means of an end cap 2, here in accordance with preference attached to the remainder of the housing by means of laser welding. The housing is provided with an entrance opening in the form of tube 3 located at the right hand side of the drawing, and an exit opening in the form of tube 3 situated at the left side. The filter 4 is internally supported by a perforated filtering means support 5, defining a cylindrical inner chamber to the filter 4 and the filter device as a whole.

The filter element 4 is here attached, in casu by gluing, to said end cap 2, and thereby closed off at its axial face near the exit opening 3. At its other axial end, an internal end cap 8 is provided, closing off this axial end, in casu by at least virtually fully covering the end face of the filter element 4. The end cap 8 is in the present configuration thereto urged against said end face by a spring means, here in the form of spring 6. The spring 6, though shaped differently, is here provided with a spring setting corresponding to that of a valve spring 11, to be discussed later.

The internal end cap 8, alternatively denoted pressure plate, is here provided with a valve 9 and valve housing 12, wherein, in a manner known per se, the valve 9 closes off an opening in said housing against force of a valve spring 11, received by the valve 12 in a valve top 10. The valve spring 11 is provided with a spring setting corresponding to that of end cap spring 6.

The filtering device according to the invention is further provided with a magnet 7, in casu shaped annular, for collecting metal particles often contained in entering hydraulics that serves to lubricate machinery, especially new machinery, thereby alleviating the filter element 4, and preventing it from becoming clogged prematurely. The magnet 7 is provided with an internal opening through which spring 6 protrudes towards and presses directly against in casu the internal end cap 8.

In the present embodiment, the internal end cap 8 is provided with an outer upstanding rim, surrounding said magnet 7. Also, a significant amount of radial play is provided for, between said rim and the annular magnet 7, preferably in the range of two to five mm, thereby receiving any debris that might slide off otherwise at e.g. strong current of entering hydraulics or at high viscosity fluid. Moreover, although die-casted synthetic materials become wide spread in filtering devices, the end cap is here produced in a metal, preferably a sheet metal, which itself also becomes magnetically by the presence of magnet 7, thereby increasing the debris holding surface of the filter device.

In the present embodiment, internal valve 10 functions as a safety valve, i.e. it solely opens when the filter element 4 has become blocked. Instead of oil entering from right hand side entry 3 and passing through the cylindrical filter 4 towards the inner chamber thereof, the hydraulics would in such case push valve 10 open against the biasing force of valve spring 11, so that hydraulics would directly enter said inner chamber, bypassing said filter 4.

In the case of installation of the device in the wrong flow direction, despite visual indications and instructions thereto on the outer wall of the housing 1, the entire internal cap 8 will function as a safety by-pass valve. Given the pressure setting of spring 6, which corresponds to that of valve spring 11, the cap 8 will in case of hydraulic blocking, now at the interior side of filter 4, function as a safety valve by becoming lifted from its position urged to the axial end face of the filter 4, against force of the spring 6.

The invention, apart from the following set of claims, also relates to the preceding description and all details and aspects in the drawing which are directly and unambiguously derivable there from, at least by a man skilled in the art.

1. A method of filtering hydraulic liquid in a system to be lubricated in which a safety means is incorporated for enabling a by-pass by opening a by-pass valve against spring force in case of blocking of a filter filtering said fluid or in case of high demand of fluid by said system, wherein a further by-pass means is incorporated by the inclusion of a second spring force having a setting corresponding to said by first pass valve spring force and wherein said second spring force is set to act opposite to said first spring force, either in contact with said by-pas valve, or in contact with a by-pass valve carrying means closing off a axial end of said filter, said carrying means urged against said axial end by said second spring force.

2. The method according to claim 1, wherein said filter is held in position, in particular relative to the filter housing, by fixation means.

3. A filter device having a housing, enclosing a filter element fixated against an axial end cap of the device, provided with a second end cap internal to the housing, unconnectedly therewith closing off the opposite axial end face of the filter element, a spring element being provided urging said internal cap against said axial end face, and a by-pass valve being provided in said end cap, opening to an internal cylindrical chamber of the filter element against spring force of a valve spring, the cap spring and the valve spring being provided with a corresponding spring setting, such that at top side down, the combination of internal cap and cap spring may act as a by-pass valve.

4. The device according to claim 3, wherein the end cap is provided with an upstanding rim, receiving an annular magnet incorporated opposite to the normal entry opening of the device, and wherein the nominal radial distance between the outer magnet circumference and said rim is of a highly significant magnitude, relative to the smallest particles to be filtered by the filter.

5. A filter device provided with a cap having an upstanding rim, receiving an annular magnet, and incorporated opposite to the normal hydraics entry opening of the device, and wherein the nominal radial distance between the outer magnet circumference and said rim is of a highly significant magnitude, relative to the smallest particles to be filtered by the filter.

6. The device according to claim 4, wherein the cap is produced in a metal.

7. The device according to claim 3, wherein the filter element is an in-depth filtering element.

8. The device according to claim 3, wherein the filtering element is to be replaced by replacing the entire device.

9. The device according to claim 3, wherein the housing and at least said second end cap are produced as a metal sheet material and wherein the second end cap and a remaining housing part are mutually sealed by a laser welding.

10. The device according to claim 3, wherein the housing and at least said second end cap are produced as a synthetic material and wherein, preferably the second end cap and a remaining housing part are mutually sealed by sonic welding.

11. The device according to claim 3, wherein top side down is an incorrect mounting of the device.

12. The device according to claim 4, wherein the nominal radial distance between the rim and the outer magnet circumference is in the range of 2 to 5 mm.

13. The device according to claim 5, wherein the nominal radial distance between the rim and the outer magnet circumference is in the range of 2 to 5 mm.

14. The device according to claim 7, wherein the filter element is a cellulose fiber based filtering element.

15. The device according to claim 10, wherein the synthetic material is phenolix.

16. The device according to claim 13, wherein the cap is produced in a metal.

17. The device according to claim 13, wherein the filter element is a cellulose fibre based filtering element.

18. The device according to claim 13, wherein the filtering element is to be replaced by replacing the entire device.

19. The device according to claim 13, wherein the housing and at least said second end cap are produced as a metal sheet material, and wherein the second end cap and a remaining housing part are mutually sealed by a laser welding.

20. The device according to claim 13, wherein the housing and at least said second end cap are produced as a synthetic material, and wherein the second end cap and a remaining housing part are mutually sealed by sonic welding.
